(19) United States
(12) Patent Application Publication
(10) Pub. No.: US 2008/0070105 A1
(43) Pub. Date: Mar. 20, 2008

(54) Battery With Clip

(75) Inventors: George Marmaropoulos, Yorktown Heights, NY (US); Giang Truong Vu, Peekskill, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/815,879

(22) PCT Filed: Mar. 2, 2006
(86) PCT No.: PCT/IB06/50654

§ 371 Date: Aug. 9, 2007

Related U.S. Application Data
(60) Provisional application No. 60/659,611, filed on Mar. 8, 2005.

(51) Int. Cl. H01M 10/00

(52) U.S. Cl. 429/122; 429/52

(57) ABSTRACT

A battery, device and method for establishing electrical communication between a power source and fabrics having electrical characteristics, such as a conductive fiber network, associated therewith is provided in which a clip that is operatively associated with a battery securely but releasably engages and/or holds fabric such that when a portion of fabric, which fabric portion includes conductive contacts corresponding to the terminals of the battery, is appropriately engaged and/or held via the clip an electrical connection between the battery and fabric can be established such that electric power or signal can be transferred to any one or more electronic devices and/or systems associated with the fabric.

The present disclosure is directed to a portable energy source such as a battery and more particularly, to an energy source suitable for use with smart textiles or fabrics.

In the design and use of smart fabrics it is often desirable that the natural characteristics (e.g., drape, flexibility, durability, etc.) associated with the fabric material be preserved. Further, in certain smart fabric applications (e.g., wearable electronics) it is important that the smart fabric be washable. Accordingly, the means by which energy or power is transferred or provided to these smart fabrics becomes a real issue. Conventionally, given the inherent need in a wide variety of smart fabric applications for a portable power supply, batteries and/or portable power generation units of various known types and/or voltages have been used. It is a disadvantage however, that often methods for connecting these different energy sources to fabric require non-intuitive, awkward, and sometimes rigid, bulky and/or unsightly connecting arrangements. Accordingly, there is a need for a portable energy source suitable to be easily connected to and removed from fabrics as desired in an efficient and intuitive manner.

Hence, according to the present disclosure a portable power source in, for example, the form of a battery is disclosed in which a fastener or clip is used for connecting the battery to various fabrics such as, for example, various smart fabrics having one or more electronic devices and/or systems associated therewith. The battery, once appropriately connected to the fabric via the clip, is suitable to provide energy to various electronic applications associated with the fabric as needed.

According to an exemplary embodiment of the present disclosure, the battery has a body in the shape of a pen or the like with a clip, which clip can be made of a resiliently flexible, preferably non-conductive material. The clip, according to a beneficial aspect of the present disclosure, is a resiliently flexible member having one end connected to the body and a free end resiliently biased relative to the body so as to securely but releasably engage and/or hold any of a variety of fabrics including, for example, various garment fabrics. Thus, in an advantageous aspect of the present disclosure, a piece of fabric associated with a garment (e.g., a pocket edge, a sleeve edge, a collar edge, or any other engageable piece) can, for example, be securely but releasably held interposed between the clip and body.

Advantageously, in another aspect of the present disclosure, the clip facilitates conductive or electrical communication between the battery and fabric. For example, with particular respect to smart fabrics, which fabrics typically include integrated conductive fibers and/or the like suitable to facilitate different electronic operations (e.g., electrical communication by and between one or more wearable electronic devices associated with the fabric), these fabrics can have conductive contacts for electrically cooperating with the battery via corresponding battery terminals when the clip appropriately engages and/or holds the fabric. That is, the clip operates to releasably hold a portion of the fabric having conductive contacts associated therewith so that the conductive contacts are held in electrical communication with the battery terminals. Thus, by engaging an appropriate piece of garment fabric (e.g., a pocket edge with conductive contacts associated therewith), energy or power can be effectively transferred to various wearable electronic applications associated with the garment via the terminal/contact connection.

A device, in another exemplary embodiment of the present disclosure, includes a power module having a battery with a clip suitable for operatively connecting the battery to fabric, and a tool module having one or more implements for performing one or more distinct functions. In an aspect of the present disclosure, the power module may beneficially include an additional battery that is operatively connectable to the first battery and suitable to recharge the first battery and/or to operate as a supplemental power source. In another aspect of the present disclosure, the one or more implements of the tool module can be any of a variety of instruments including light sources (e.g., flashlight, laser pointer, etc.), writing instruments (e.g., ink pen, mechanical pencil, marker, etc.), sensors (e.g., environmental sensors, etc.) and the like.

An advantageous method, according to still another exemplary embodiment of the present disclosure, includes the steps of: (i) providing a battery having a clip suitable for operatively connecting the battery to fabric, and (ii) connecting the battery to fabric via the clip. The battery, in an advantageous aspect of the present disclosure, includes a pair of adjacent terminals operatively associated with an energy source accommodated by the battery body. These adjacent terminals are connectable to corresponding conductive contacts associated with the fabric so as to provide energy to one or more electronic applications likewise associated with the fabric.

Additional advantageous features, aspects and functions relating to the present disclosure will be apparent from the detailed description which follows, particularly when reviewed together with the appended figures, which figures are referenced to assist those of ordinary skill in the art to which the subject matter of the present disclosure appertains to better understand the exemplary embodiments of the present disclosure, wherein:

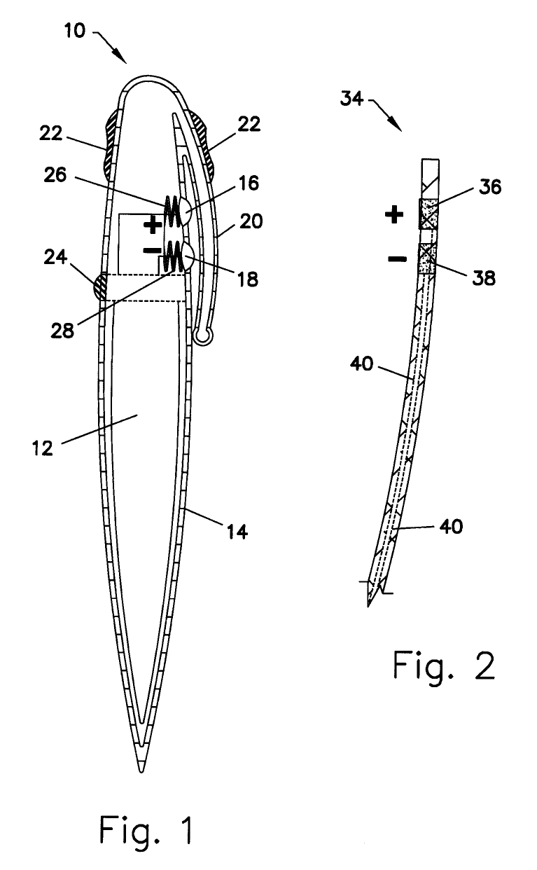

FIG. 1 is a schematic representation of an exemplary battery according to an illustrative embodiment of the present disclosure;

FIG. 2 is a cross-sectional view of an exemplary fabric arrangement according to an illustrative aspect of the present disclosure;

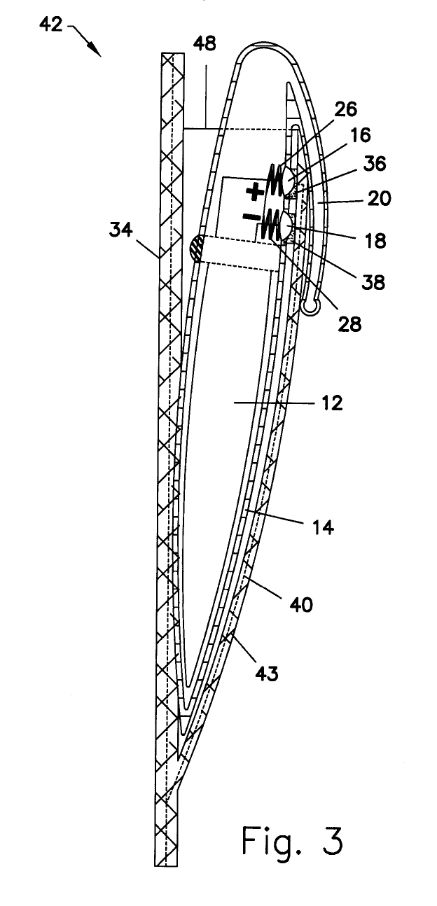

FIG. 3 is a schematic demonstration of an exemplary battery-fabric connection in accordance with an illustrative aspect of the present disclosure;

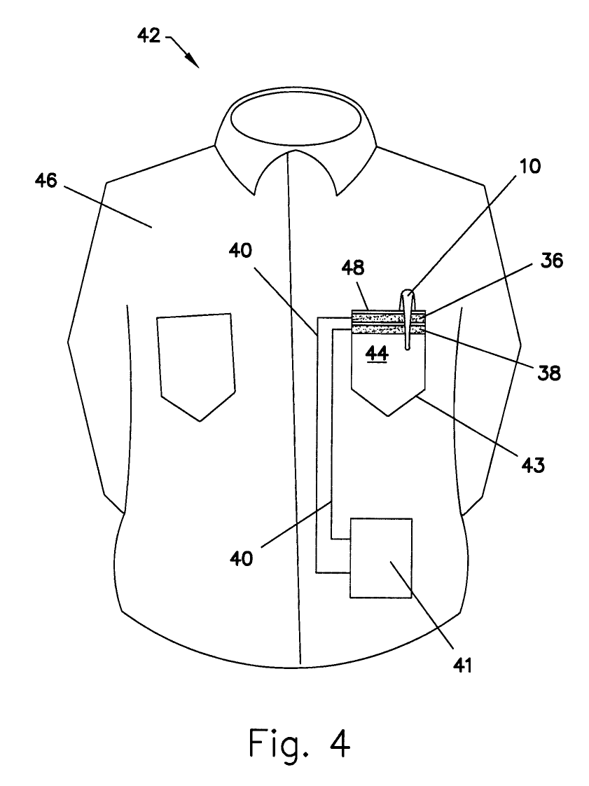

FIG. 4 is a schematic representation of an exemplary smart garment according to an illustrative aspect of the present disclosure;

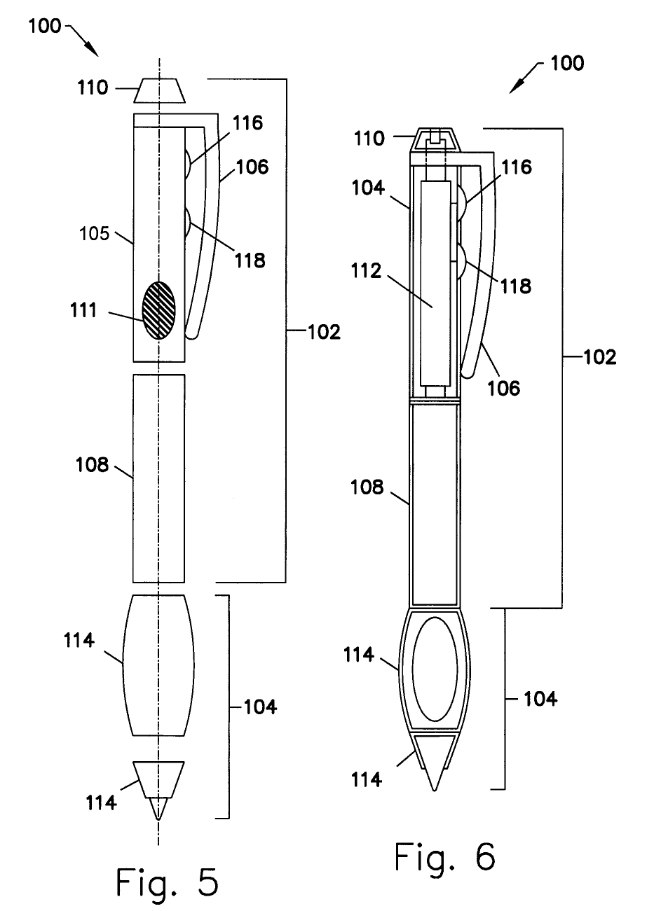

FIG. 5 is an exploded view of a device according to an exemplary embodiment of the present disclosure; and

FIG. 6 is a cross-sectional view of the device of FIG. 4a.

With reference to the drawings, it should be understood that notwithstanding the following detailed description of the various exemplary embodiments and/or aspects of the present disclosure referring to the drawings which form a part hereof, other additional and/or alternative embodiments, aspects and/or features may equally be used without departing from the scope of the present disclosure as the advantageous features of the present disclosure may be employed in any of a variety of applications including, for example, any electrical application requiring a secure but releasably connectable portable power source.

With initial reference to FIG. 1, there is shown a battery 10 according to an exemplary embodiment of the present disclosure. As shown, the battery 10 includes an energy source 12, a body 14 for accommodating the energy source 12, a pair of terminals 16, 18 accessible from without the body 14 and operatively associated with the energy source 12, and a clip 20 suitable to operatively connect the battery 10 to fabric and preferably situated to provide protection to the terminals 16, 18.

The energy source 12, in an aspect of the present disclosure, can derive energy from a variety of chemicals reactions such as, for example, conventionally provided by zinc-carbon batteries, alkaline batteries, lithium photo batteries, rechargeable lead-acid batteries, rechargeable nickel-cadmium batteries, rechargeable nickel-metal hydride batteries, rechargeable lithium-ion batteries, zinc-air batteries, zinc-mercury oxide batteries, silver-zinc batteries, and/or metal-chloride batteries. As will be readily understood to those skilled in the pertinent art from the present disclosure, the energy source 12 may equally derive energy or power from any of a variety of other means. For example, the energy source 12 may derive energy from an appropriate fuel cell arrangement. In addition, the energy source 12, in a preferred aspect of the present disclosure, can be rechargeable such as by induction or inductive charging.

The body 14, although shown as having a relatively elongated substantially tubular body (i.e., pen-shaped) may, in other aspects of the present disclosure, have any of a variety of other forms and/or configurations suitable for accomplishing different aesthetic and/or functional effects. In addition, the body 14 can be formed of any of a variety of preferably non-conductive materials, which may likewise facilitate accomplishing different aesthetic and/or functional effects. As shown, the body 14 is preferably an integral structure that can be made to be water resistant. The body 14 may be provided with ergonomic features such as, for example, gripping means 22 suitable for enabling an individual to readily grasp and/or handle the battery 10 as needed. Additionally, the body 14, in other aspects of the present disclosure, can include various control features such as, for example, a power flow control 24 capable of controlling the voltage output provided by the battery 10. Such a control 24 could have predefined voltage output settings associated therewith (e.g., 1.25V, 1.5V, 3V, 5V, 6V, 9V, etc.). As shown, the control 24 is in the form of a button, but as will be readily apparent to those skilled in the pertinent art from the present disclosure, the control 24 equally may have any of a variety of different configurations such as a dial or a sliding mechanism.

The terminals 16, 18, as previously stated, are operatively associated with the energy source 12 and can be accessed from without the body 14. Thus, the terminals 16, 18 facilitate transferring power from the energy source 12 located in the body 14 to various applications, systems and/or devices external to the body 14. As shown, the terminals 16, 18, in a preferred aspect of the present disclosure, are adjacent to each other with defining a positive pole and the other a negative pole. Preferably, a biasing means is associated with each terminal 16, 18. For example, as shown, a spring 26, 28 may be operatively connected to each terminal 16, 18 so as to cause such terminals to be biased against corresponding conductive contacts associated with an electronic application and thereby establish a stable and efficient electrical connection.

The clip 20, which is preferably situated so as to provide protection to the terminals 16, 18, is, in accordance with a preferred aspect of the present disclosure, integral to the body 14 and formed of a preferably non-conductive material that need not be identical to that of the body 14. The clip 20, as shown, is an appendage or an extension of the body 14 being defined by a fixed end 30 located at the interface of the clip 20 and the body 14 and a free end 32 resiliently biased against the surface of the body 14 so as to be able to securely but releasably engage and/or hold a planar material (e.g., a piece of fabric) between the free end 32 and the surface of the body 14.

It is noted that the clip 20, in alternative aspects of the present disclosure, may be separably connected to body or battery so as to be replaceable and/or interchangeable with other clips in the event of damage due, for example, to fatigue from repetitive use.

Turning to FIG. 2, there is shown a side cross-sectional view of an exemplary fabric 34 suitable for cooperating with the battery 10. Preferably, the fabric 34 is suitable for use in association with electronic applications in general, and more preferably, with wearable electronic applications. The fabric 34 may be formed from any type of material whether manmade (e.g., rubber, Mylar, polyurethane, etc.), natural (e.g., cotton, wool, silk, etc.), or composite (e.g., polypyrrole/nylon, polypyrrole/lycra, polypyrrole/polyester, etc.), including all materials typically used in the manufacture of clothing.

As shown, the fabric 34 includes conductive contacts 36, 38 preferably suitable for operatively connecting to corresponding terminals 16, 18 associated with the battery 10. In addition, the fabric 34 includes conductive tracks 40 operatively connectable to one or more electronic applications associated with the fabric 34. The conductive tracks 40, according to a preferred aspect of the present disclosure, cooperate with the conductive contacts 36, 38 so as to connect any one or more electronic application associated with the fabric 34 to the battery 10 by way of terminals 16, 18.

The conductive contacts 36, 38 and/or conductive tracks 40 can be fashioned from any of a variety of materials having conductive characteristics associated therewith. For example, the conductive contacts 36, 38 and/or conductive tracks 40 can be fashioned using flexible metal coated materials including woven, non-woven, and/or knits, filaments, foils, and yarns, conductive polymer coated materials, conductive graphitized materials, conductive gel coated materials, cotton, lycra, spandex, neoprene, polyester, rubber extruded materials, polypyrrole/lycra materials, polypyrrole/nylon materials, polypyrrole/polyester materials, any conjugated polymer, ion-implanted polymers and/or any combination of the same. Further, the conductive contacts 36, 38 and/or conductive tracks 40 can be formed using any of a variety of known textile manufacturing techniques including, for example, various weaving, knitting, sewing, coating, and/or injecting techniques. Still further, the conductive contacts 36, 38 and/or conductive tracks 40 can have any of a variety of different shapes, sizes and/or configurations so as to be complementary with terminals associated with different battery configurations. The conductive contacts 36, 38 and conductive tracks 40, according to a beneficial aspect of the present disclosure, have characteristics suitable to provide appropriate flexibility and durability to withstand the stresses associated with the manufacture and use of a variety of different types of textile constructions.

It is noted that the conductive contacts 36, 38 and/or conductive tracks 40, in other aspects of the present disclosure, may be fashioned from a combination or mesh of conductive and non-conductive fibers using any known conventional method for weaving, sewing and/or knitting. In this aspect, each fiber can have any of a variety of forms and can be any of a variety of materials and/or combination of materials appropriate to accommodate different desired electronic applications.

With reference now to FIGS. 3 and 4, the battery 10 with clip 20, according to an exemplary embodiment of the present disclosure, provides portable means for energizing various smart textiles or fabrics 42, which fabrics typically include integrated conductive fibers and/or the like suitable to facilitate various electronic operations (e.g., electrical communication by and between one or more wearable electronic devices and/or systems 41 associated with the fabric). These smart fabrics 42, as shown in FIG. 3, can include conductive contacts 36, 38, such as previously discussed, that are suitable for electrically cooperating with preferably adjacent battery terminals 16, 18 so as to establish an effective electrical connection when the clip 20 is used to engage and/or hold a portion 43 of the smart fabric 42 having conductive contacts 36, 38 associated therewith so that the conductive contacts 36, 38 electrically communicate with the battery terminals 16, 18. Thus, the clip 20, according to an advantageous aspect of the present disclosure, is preferably suitable to releasably connect the battery 10 to fabric, and more preferably suitable to releasably connect the battery 10 to portions 43 of smart fabric 42 having conductive contacts 36, 38 for cooperating with the terminals 16, 18 of the battery 10.

It is noted that the various portions 43 of the smart fabric 42 can be associated with any of a variety of garments, upholsteries, or other textile products. For example, as shown in FIG. 4, in an aspect of the present disclosure, the portion 43 of smart fabric 42 is in the form of a pocket 44 in a shirt 46 having an edge 48 and conductive contacts 36, 38 associated therewith. Other suitable portions of fabric might include a collar or sleeve edge, a fold or crease established by folding the fabric over itself, and/or any seam having conductive contacts suitable for cooperating with the terminals of the battery. Thus, according to an advantageous feature of the present disclosure, an individual can easily establish electrical communication with various garments, upholsteries, or other textile products so as to transfer electric power or signal suitable to operate any of a variety of electrical devices and/or systems associated with such garments, upholsteries, or other textile products, and to thereby accomplish any of a variety of desired effects.

Referring to FIGS. 5 and 6, there is shown a device 100 according to another exemplary embodiment of the present disclosure. As shown, a power module 102 and a tool module 104 define the device 100.

The power module 102 includes a first battery 105 with a clip 106, such as heretofore described, and may, in an aspect of the present disclosure, include an additional power source, such as a second battery 108, suitable for providing a supplementary source of power. In addition, the power module 102, in another aspect of the present disclosure, includes an interface 110 suitable for communicating electric power or signal directly to any of a variety of remote electrical devices and/or systems. Furthermore, in still another aspect of the present disclosure, the power module 102 is provided with a control 112 suitable for controlling power flow. Such control 112 can take any of a variety of forms (e.g., button, knob, dial, etc.) and have indicia associated therewith indicating various voltage output settings.

One or more implements 114 suitable for accomplishing distinct functions define the tool module 104, which is preferably operatively connectable with the power module 102. For example, in an aspect of the present disclosure, the implement 114 is a marking instrument (e.g., pen, pencil or maker). In another aspect of the present disclosure, the implement 114 is an illuminating instrument (e.g., flashlight or laser pointer). In still another aspect of the present disclosure, the implement 114 is a sensing instrument (e.g., environmental sensor). As will be readily apparent to those skilled in the art from the present disclosure, it is noted that the power module 102 is preferably suitable to provide power, as appropriate, to any of the implements 114 associated with the tool module 104.

Accordingly, the device 100, in an advantageous aspect of the present disclosure, is suitable to accomplish a multitude of different functions including, inter alia, providing means for directly powering remote electronic applications, providing means for illuminating, providing means for writing and/or marking, and/or providing means sensing, as well as providing means for powering electronic applications associated with fabrics (e.g., smart textiles or garments).

The many aspects, features and advantages identified and described herein are apparent from the foregoing detailed discussion and, thus, it is intended by the appended claims to cover all such aspects, features and advantages that fall within the spirit and scope of the present disclosure. Further, since numerous modifications and changes will readily occur to those skilled in the art, it is not desired to limit the scope of the present disclosure to the exact construction and operation illustrated and described, and accordingly all suitable modifications and equivalents may be resorted to as falling within the present disclosures scope. Thus, the exemplary embodiments described herein are merely illustrative and the present disclosure specifically encompasses alternative and/or modified embodiments of that which has been disclosed.

1. A battery (10) comprising:
an energy source (12);
a body (14) for accommodating said energy source (12);
a pair of terminals (16, 18) accessible from without said body (14) and operatively associated with said energy source (12); and
a clip (20) operatively associated with said body (14),
wherein said clip (20) is suitable for operatively connecting the battery (10) to fabric.

2. The battery (10) of claim 1, wherein said clip (20) is situated relative to said terminals (16, 18) so as to provide protection thereto.

3. The battery (10) of claim 1, wherein said clip (20) is non-conductive.

4. The battery (10) of claim 1, wherein said body (14) is in the shape of a pen.

5. The battery (10) of claim 1, wherein the battery (10) is rechargeable.

6. The battery (10) of claim 1, wherein the battery (10) is operatively associated with at least one implement (114) for performing one or more distinct functions.

7. The battery (10) of claim 1, wherein the battery (10) includes a controller (24) for controlling power flow.

8. The device of claim 1, wherein said terminals (16, 18) are suitable for operatively connecting with a corresponding pair of conductive contacts (36, 38) associated with a fabric (34, 42).

9. The device of claim 8, wherein said clip (20) holds said conductive contacts (36, 38) of said fabric (34, 42) and said terminals (16, 18) of the battery (10) together to enable conductive communication therebetween.

10. A device comprising:
a power module (102) including a first battery (105) with a clip (106); and
a tool module (104) including one or more implements (114) for performing one or more distinct functions,
wherein said clip (106) is suitable for operatively connecting said power module (102) to fabric (34, 42).

11. The device of claim 10, wherein said power module (102) includes a second battery (108) operatively connectable to said first battery (105).

12. The device of claim 10, wherein at least one of said one or more implements (114) is selected from a group consisting of a light source, a marking instrument, and a sensor.

13. The device of claim 10, wherein said power module (102) includes recharging means.

14. The device of claim 10, wherein said power module (102) includes a controller (111) for controlling power flow.

15. The device of claim 10, wherein said first battery (105) has a pair of adjacent terminals (116, 118) suitable for operatively connecting to a corresponding pair of conductive contacts (36, 38) associated with a fabric (34, 42).

16. The device of claim 15, wherein said clip (106) is suitable to hold said conductive contacts (36, 38) of said fabric (34, 42) and said terminals (116, 118) of said first battery (105) together and thereby facilitate conductive communication therebetween.

17. A method comprising:
providing a battery (10, 100) with a clip (20, 106) suitable for operatively connecting said battery (10, 100) to fabric (34, 42), and
connecting said battery (10, 100) to said fabric (34, 42) via said clip (20, 106).

18. The method of claim 17, wherein said battery (10, 100) includes a pair of adjacent terminals (16, 18, 116, 118) operatively associated with an energy source (12, 112) in said battery (10, 100).

19. The method of claim 18, wherein said step of connecting said battery (10, 100) to said fabric (34, 42) includes connecting said terminals (16, 18, 116, 118) to corresponding conductive contacts (36, 38) associated with said fabric (34, 42).

20. The method of claim 19, wherein said fabric (34, 42) is garment fabric (46) with one or more electronic applications (40, 41) associated therewith so as to be electrically connectable to said battery (10, 100).
